(19) United States
(12) Patent Application Publication
(10) Pub. No.: US 2025/0359656 A1
(43) Pub. Date: Nov. 27, 2025

(54) CONTROL METHOD, DEVICE, AND STORAGE MEDIUM FOR ORAL CLEANING EQUIPMENT

(71) Applicant: CIXI SEAGO ELECTRONICS CO., LTD, Cixi (CN)

(72) Inventors: Yanzhong Cai, Cixi (CN); Zhuting Dong, Cixi (CN); Yuli Wang, Cixi (CN)

(21) Appl. No.: 19/033,548

(22) Filed: Jan. 22, 2025

(30) Foreign Application Priority Data
May 27, 2024 (CN) 202410671159.X

(51) Int. Cl. A46B 15/00; A46B 13/02; A61C 17/02; A61C 17/22; A61C 17/34

(52) U.S. Cl. CPC A46B 15/0004; A46B 13/023; A46B 15/0044; A61C 17/02; A61C 17/221; A61C 17/3481

(57) ABSTRACT

A control method, a device, and a storage medium for oral cleaning equipment are provided. The oral cleaning equipment has at least two cleaning modes, and is provided with a mode control for selecting the cleaning mode. The oral cleaning equipment is start in response to a device startup command. The selection operation applied to the mode control is obtained. Under the condition that the operating state of the oral cleaning equipment meets a preset condition, the oral cleaning equipment is controlled to maintain the target cleaning mode selected before the operating state reaches the preset condition, enabling that the oral cleaning equipment, under the condition that the operating state meets the preset condition, no longer responds to the selection operation applied to the mode control.

### CROSS REFERENCE TO RELATED APPLICATIONS

The present application which claims the benefit of Chinese Patent Application No. 202410671159X filed on May 27, 2024, the contents of which are incorporated herein by reference in their entirety.

### TECHNICAL FIELD

The present disclosure relates to the technical field of oral care, and particularly, to a control method, a device, and a storage medium for oral cleaning equipment.

### BACKGROUND ART

Currently, oral cleaning equipment is generally provided with a motor therein, and the oral cleaning function is achieved by controlling the operation of the motor. For example, an electric toothbrush achieves brushing function through high-frequency vibrations produced by the brush head under driving of rotation or vibration of the motor. For another example, an electric oral irrigator achieves a function of oral irrigation through pumping liquid outward by the motor.

To meet oral cleaning needs of different users, oral cleaning equipment possibly have multiple cleaning modes. At the same time, the oral cleaning equipment also provides a mode control for users to select an appropriate cleaning mode by triggering the mode control.

However, during use, there are often situations where the mode control is accidentally triggered, causing the oral cleaning equipment to operate in a cleaning mode not desired by the user, thereby affecting the use effect of the oral cleaning equipment.

### SUMMARY

In view of this, the present disclosure provides a control method, a device, and a storage medium for oral cleaning equipment, which can solve the problem of a high probability of oral cleaning equipment responding to misoperations.

According to a first aspect of the present disclosure, a control method for oral cleaning equipment is provided. The oral cleaning equipment has at least two cleaning modes, and is provided with a mode control configured for selecting the cleaning mode, and the method includes steps of:
starting the oral cleaning equipment in response to a device startup command;
obtaining a selection operation applied to the mode control; and
controlling, once an operating state of the oral cleaning equipment meeting a preset condition, the oral cleaning equipment to maintain a target cleaning mode selected before the operating state meets the preset condition,
wherein the selection operation is used to indicate change of the target cleaning mode, and the target cleaning mode is one of the at least two cleaning modes.

In one possible implementation, the step of controlling, once an operating state of the oral cleaning equipment meeting a preset condition, the oral cleaning equipment to maintain a target cleaning mode selected before the operating state meets the preset condition includes:
disabling the mode control, once the operating state meets the preset conditions, so as to control, upon obtaining the selection operation, the oral cleaning equipment to maintain the target cleaning mode selected before the operating state meets the preset condition.

In one possible implementation, the mode control is implemented through a touch display screen, and correspondingly, the method further includes:
controlling, after obtaining the device startup command, the touch display screen to light up, and establishing a communication connection with the touch display screen to respond to a touch operation applied to the touch display screen.

Correspondingly,
the step of disabling the mode control includes:
disconnecting the communication connection to stop responding to the touch operation applied to the touch display screen, wherein the touch operation comprises the selection operation.

In one possible implementation, after the step of disabling the mode control, the method further includes:
obtaining a disable-release command, to control, upon obtaining the selection operation, the oral cleaning equipment to change the target cleaning mode to the cleaning mode indicated by the selection operation.

In one possible implementation, the oral cleaning equipment is further provided with a manipulation control independent of the mode control, and correspondingly, the method further includes:
generating the disable-release command, upon receiving a first preset operation applied to the manipulation control.

In one possible implementation, the operating state comprises: a working state according to the target cleaning mode, and correspondingly, the method further includes:
controlling, based on the first preset operation, the oral cleaning equipment to stop operating according to the target cleaning mode.

In one possible implementation, the method further includes:
controlling, in a case where the oral cleaning equipment is started, the oral cleaning equipment to shut down when a second preset operation applied to the manipulation control is received.

In one possible implementation, the step of starting the oral cleaning equipment in response to a device startup command includes:
generating, in a case where the oral cleaning equipment is shut down, the device startup command to start the oral cleaning equipment when the second preset operation applied to the manipulation control is received.

In one possible implementation, the step of controlling, once an operating state of the oral cleaning equipment meeting a preset condition, the oral cleaning equipment to maintain a target cleaning mode selected before the operating state meets the preset condition, includes:
controlling, in response to a working command for starting the target cleaning mode, the oral cleaning equipment to operate according to the target cleaning mode; and
controlling, in a case where a working duration of the target cleaning mode is greater than a first duration threshold, the oral cleaning equipment to continue operating according to the target cleaning mode.

In one possible implementation, the step of controlling, once an operating state of the oral cleaning equipment meeting a preset condition, the oral cleaning equipment to maintain a target cleaning mode selected before the operating state meets the preset condition includes:
controlling, in a case where a continuous standby duration of the oral cleaning equipment in a standby state is greater than a second duration threshold, the oral cleaning equipment to maintain the cleaning mode selected before the continuous standby duration meets the second duration threshold; and
the standby state refers to a state in which the oral cleaning equipment is started and does not operate according to any cleaning mode, and the continuous standby duration refers to a duration during which the oral cleaning equipment continuously remains in the standby state.

In one possible implementation, the method further includes:
controlling, in a case where the operating state of the oral cleaning equipment does not meet the preset condition, the oral cleaning equipment to change the target cleaning mode to the cleaning mode indicated by the selection operation.

According to another aspect of the present disclosure, a control device for oral cleaning equipment is provided. The oral cleaning equipment has at least two cleaning modes, and is provided with a mode control configured for selecting the cleaning mode, and the device includes:
a startup module, configured for starting the oral cleaning equipment in response to a device startup command;
an interaction module, configured for obtaining a selection operation applied to the mode control; and
a control module, configured for controlling, once an operating state of the oral cleaning equipment meeting a preset condition, the oral cleaning equipment to maintain a target cleaning mode selected before the operating state meets the preset condition,
wherein the selection operation is used to indicate change of the target cleaning mode, and the target cleaning mode is one of the at least two cleaning modes.

According to another aspect of the present disclosure, a control device for oral cleaning equipment is provided, including:
a processor; and a memory configured for storing processor-executable instructions, wherein the processor is configured to implement the above method when executing the instructions stored in the memory.

According to another aspect of the present disclosure, a non-volatile computer-readable storage medium is provided, on which computer program instructions are stored, wherein the computer program instructions, when executed by a processor, implement the above method.

According to another aspect of the present disclosure, a computer program product is provided, including computer-readable code, or a non-volatile computer-readable storage medium carrying computer-readable code, wherein when the computer-readable code is run in the processor of an electronic device, the processor of the electronic device performs the above method.

The oral cleaning equipment is started by responding to the device startup command, and the selection operation applied to the mode control is obtained. Under the condition that the operating state of the oral cleaning equipment meets a preset condition, the oral cleaning equipment is controlled to maintain the target cleaning mode selected before the operating state reaches the preset condition, enabling that the oral cleaning equipment, under the condition that the operating state meets the preset condition, no longer responds to the selection operation applied to the mode control. During this period, even if misoperation occurs, the oral cleaning equipment will not respond to the misoperation; This can solve the problem of the high probability of oral cleaning equipment responding to misoperations, and improve the use effect of the oral cleaning equipment.

According to the detailed description of exemplary embodiments with reference to the following drawings, other features and aspects of the present disclosure will become clear.

### BRIEF DESCRIPTION OF DRAWINGS

The drawings, which are included in the specification and constitute a part of the specification, illustrate exemplary embodiments, features, and aspects of the present disclosure and are used to explain the principles of the present disclosure.

FIG. 1 shows a schematic diagram of the oral cleaning equipment according to an embodiment of the present disclosure;

FIG. 2 shows a block diagram of the oral cleaning equipment according to an embodiment of the present disclosure;

FIG. 3 shows a flowchart of a control method for the oral cleaning equipment according to an embodiment of the present disclosure;

FIG. 4 shows a flowchart of a control method for the oral cleaning equipment according to another embodiment of the present disclosure;

FIG. 5 shows a flowchart of a control method for the oral cleaning equipment according to yet another embodiment of the present disclosure; and

FIG. 6 shows a block diagram of a control device for the oral cleaning equipment according to an embodiment of the present disclosure.

### DETAILED DESCRIPTION OF EMBODIMENTS

The following will detail various exemplary embodiments, features, and aspects of the present disclosure with reference to the drawings. The same reference numerals in the drawings represent functionally identical or similar components. Although various aspects of the embodiments are shown in the drawings, the drawings need not be scaled unless specifically indicated.

The term “exemplary” as used here means “used as an example, embodiment, or illustrative”. Any embodiment described as “exemplary” herein should not be construed as being superior to or better than other embodiments.

In addition, for a better explanation of the present disclosure, numerous specific details are provided in the following detailed embodiments. It should be understood by those skilled in the art that the present disclosure may be practiced without some of the specific details. In some examples, methods, means, components, and circuits well known to those skilled in the art are not described in detail to highlight the main concepts of the present disclosure.

In the present disclosure, oral cleaning equipment refers to electronic devices capable of performing oral cleaning functions through electric control. The types of oral cleaning equipment include, but are not limited to: electric toothbrushes, toothbrush handle parts of electric toothbrushes, electric oral irrigators, etc. The present disclosure does not limit the types of oral cleaning equipment.

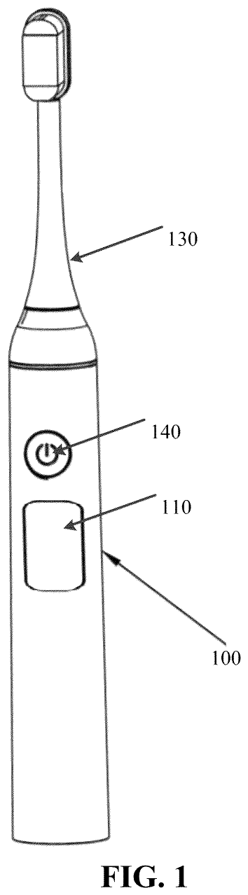

FIG. 1 shows a schematic diagram of oral cleaning equipment according to the embodiment of the present disclosure, and the schematic diagram takes an electric toothbrush as an example of oral cleaning equipment. As shown in FIG. 1, the oral cleaning equipment 100 at least includes: a mode control 110, a control module 120 (not shown in FIG. 1), and an execution component 130.

The control module 120 is configured to control the entire oral cleaning equipment, with control content including, but not limited to: controlling on or off of the equipment power, controlling start or stop of cleaning work, controlling the current cleaning mode of the execution component 130, etc. The embodiment does not limit the control content of control module 120.

The execution component 130 is communicatively connected to the control module 120 and is configured to execute oral cleaning actions under the control of the control module 120. For different types of the oral cleaning equipment, the implementation of the execution component 130 varies.

In one example, if the oral cleaning equipment is an electric toothbrush, the execution component 130 at least includes: a motor and a toothbrush head connected to the motor. Thus, the motor operates to drive the toothbrush head to vibrate and perform a brushing action.

In another example, if the oral cleaning equipment is a toothbrush handle of the electric toothbrush, the execution component 130 at least includes a motor. Thus, after mounting the toothbrush head on the oral cleaning equipment, the motor works to drive the toothbrush head to vibrate and perform the brushing action.

In another example, if the oral cleaning equipment is an electric oral irrigator, the execution component 130 at least includes: a motor, a liquid storage chamber, and an irrigation head connected to the motor. Thus, the motor operates to pump out liquid from the storage chamber through the irrigation head, achieving the oral irrigation action.

In the embodiment, the control module 120 can control the execution component 130 to work under at least two cleaning modes. For different cleaning modes, the working parameters of execution component 130 differ. In other words, for any one of the at least two cleaning modes, the control module 120 controls the execution component 130 to work according to the working parameters corresponding to the cleaning mode, thereby realizing the oral cleaning function corresponding to the cleaning mode.

The working parameters include, but are not limited to: preset working duration, working current of the execution component 130, working power, motor speed, motor vibration amplitude, and/or motor vibration frequency, etc. The embodiment does not limit the type of working parameters.

Taking the oral cleaning equipment as an electric toothbrush as an example, the cleaning modes include, but are not limited to: power cleaning mode, daily cleaning mode, gentle cleaning mode, polishing cleaning mode, and massage cleaning mode.

The power cleaning mode provides stronger cleaning performance than other cleaning modes. For example, the preset working duration of the power cleaning mode is greater than the preset working duration of other cleaning modes, and the motor vibration frequency in the power cleaning mode is greater than the motor vibration frequency in other cleaning modes.

The daily cleaning mode provides cleaning performance lower than that of the power cleaning mode. For example, the preset working duration of the daily cleaning mode is shorter than the preset working duration of the power cleaning mode, and the motor vibration frequency in the daily cleaning mode is lower than the motor vibration frequency in the power cleaning mode.

The gentle cleaning mode provides cleaning performance lower than that of the daily cleaning mode. For example, the corresponding preset working duration of the gentle cleaning mode is less than the preset working duration of the daily cleaning mode, and the motor vibration frequency in the gentle cleaning mode is less than the motor vibration frequency in the daily cleaning mode.

The polishing cleaning mode provides stronger cleaning performance for the gaps and surfaces of the teeth. For example, the motor vibration amplitude in the polishing cleaning mode is greater than the motor vibration amplitude in other cleaning modes.

The massage cleaning mode provides a massaging function for gums. For example, the motor vibration frequency in the massage cleaning mode is lower than the motor vibration frequency in other cleaning modes, and the motor vibration amplitude in the massage cleaning mode is lower than the motor vibration amplitude in other cleaning modes.

The division of cleaning modes above is only illustrative. In actual implementation, they can also be divided into other types or a greater or smaller number of cleaning modes. The embodiment does not limit the division manner of cleaning modes.

In the embodiment, the oral cleaning equipment is provided with a mode control 110. After the oral cleaning equipment is started (or powered on), the mode control 110 can establish communication with the control module 120, so that the control module 120 can respond to the selection operation applied to the mode control 110 to control the execution component 130 to perform the cleaning mode indicated by the selection operation.

Optionally, the mode control 110 includes, but is not limited to: a pressure-sensitive control, or a capacitive control, etc. The embodiment does not limit the implementation method of the mode control 110.

The pressure-sensitive control generally includes a pressure sensor arranged on the surface of the control panel. When pressure is applied to the surface of the control panel, the control panel deforms, and the pressure sensor detects the deformation and converts it into a corresponding analog signal. The control module 120 can determine whether the mode control 110 has been triggered based on the analog signal.

The capacitive control generally uses the capacitance of the human body as the signal source. When the human body approaches or touches the control, the capacitance between the human body and the control changes. The control module 120 can determine whether the mode control 110 has been triggered based on the capacitance.

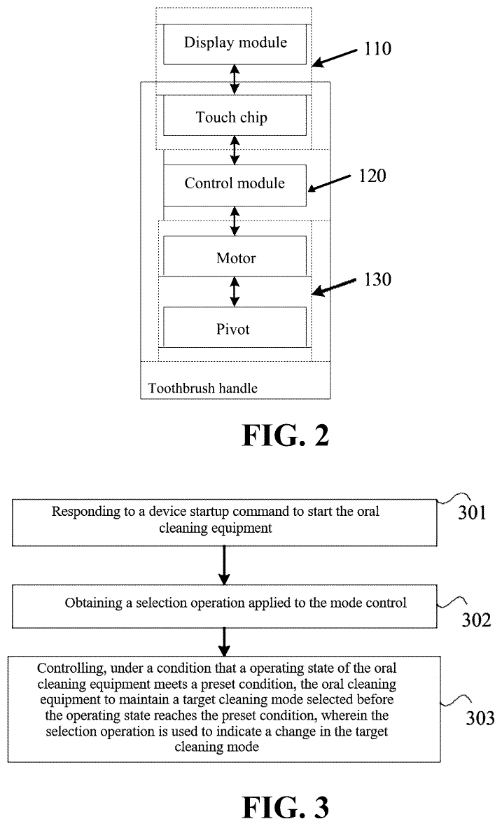

In one example, with reference to the block diagram of the oral cleaning equipment shown in FIG. 2, the block diagram illustrates the case where the oral cleaning equipment is a toothbrush handle of the electric toothbrush, and the mode control 110 is implemented via a touch display screen. As shown in FIG. 2, the touch display screen includes a touch chip and a display module, wherein the touch chip is arranged in the oral cleaning equipment, and the display module is arranged on the outer surface of the oral cleaning equipment.

The display module integrates a display screen and a capacitive control. The display screen is configured to display the device information of the oral cleaning equipment, and the capacitive control is configured to receive the selection operation for selecting the cleaning mode.

The touch chip is configured to convert the touch operation applied to the display module into a touch command readable by the control module 120, so that the control module 120 can respond to the touch command.

After the oral cleaning equipment is started, the control module 120 establishes a communication connection with the touch chip to obtain the touch command generated by the touch chip. Optionally, the control module 120 can establish a communication connection with the touch chip when the oral cleaning equipment is started; or, after the oral cleaning equipment is started, if the control module 120 receives a command to activate the touch display screen, it establishes a communication connection with the touch chip. The embodiment does not limit the timing of establishing the communication connection.

Optionally, the device information is used to indicate the operating status of the oral cleaning equipment. For example, the device information includes: the mode information of the target cleaning mode currently selected by the oral cleaning equipment. In other embodiments, the device information can also include: the mode information of the cleaning mode not currently selected by the oral cleaning equipment, and/or the remaining battery level of the oral cleaning equipment, etc. The embodiment does not list all the contents of the device information.

Herein, the mode information can be an icon, name, and/or number of the cleaning mode, etc. The embodiment does not limit the implementation of the mode information.

In other embodiments, the mode information can also be indicated by indicator lights. For example, the outer surface of the oral cleaning equipment is provided with at least two indicator lights, with each indicator light corresponding to a cleaning mode; when a target cleaning mode is selected, the indicator light corresponding to the target cleaning mode lights up, and the indicator lights in other positions turn off. The embodiment does not limit the display method of the device information.

In the embodiment, the mode control 110 is generally prone to accidental triggering during the use of the oral cleaning equipment. In this case, if the control module 120 erroneously responds to the accidental triggering, it will affect the use of the oral cleaning equipment.

For example, when the mode control 110 is implemented as a capacitive control, not only can the capacitance of the human body be used as a signal source, but water droplets in contact with the mode control 110 can also serve as a signal source of the capacitance. Therefore, if water droplets splash onto the mode control 110 during the operation of the oral cleaning equipment by the user, the control module 120 is possible to erroneously respond to the triggering operation caused by the water droplets splashing onto the mode control 110, thereby affecting the performance of the oral cleaning equipment.

For another example, when the mode control 110 is implemented as a pressure-sensitive control, during the operation of the oral cleaning equipment, the finger or palm of the user is possible to accidentally press the pressure-sensitive control. The control module 120 may erroneously respond to the pressing operation, thereby affecting the performance of the oral cleaning equipment.

Based on the above technical issues, in the embodiment, the control module 120 is configured for: starting the oral cleaning equipment in response to a device startup command; obtaining a selection operation applied to the mode control 110; and controlling, under a condition that an operating state of the oral cleaning equipment meets a preset condition, the oral cleaning equipment to maintain a target cleaning mode selected before the operating state reaches the preset condition.

The selection operation is used to indicate a change in the target cleaning mode.

Optionally, the operating state includes, but is not limited to, at least one of the following states: standby state and working state. The standby state refers to a state in which the oral cleaning equipment is started and does not operate according to any cleaning mode. The working state refers to a state where the oral cleaning equipment operates according to the target cleaning mode, and the target cleaning mode is one of at least two cleaning modes.

Each operating state corresponds to one selected target cleaning mode.

In one example, the operating state is a working state. Accordingly, prior to the operating state reaching the preset condition, the selected target cleaning mode is the cleaning mode in which the oral cleaning equipment is currently operating.

For example, in the working state, if the oral cleaning equipment operates in cleaning mode A prior to the operating state reaching the preset condition, the selected target cleaning mode prior to the operating state reaching the preset condition is cleaning mode A.

For another example, in the working state, if the oral cleaning equipment first operates in cleaning mode A and then switches to cleaning mode B before the operating state reaches the preset condition, the selected target cleaning mode prior to the operating state reaching the preset condition is cleaning mode B.

In another example, the operating state is a standby state. Accordingly, prior to the operating state reaching the preset condition, the selected target cleaning mode is the cleaning mode that is run when switching from the standby state to the working state.

For example, after the oral cleaning equipment is started and enters the standby state, and cleaning mode A is selected by default. Although the oral cleaning equipment does not operate in cleaning mode A, once it switches form the standby state to the working state, the oral cleaning equipment will operate in cleaning mode A. Therefore, the selected target cleaning mode prior to the operating state reaching the preset condition is cleaning mode A.

For another example, in the standby state, the oral cleaning equipment defaults to cleaning mode A, and then the selected cleaning mode is changed to cleaning mode B. Once the oral cleaning equipment switches from the standby state to the working state, it will operate in cleaning mode B. Therefore, the selected target cleaning mode prior to the operating state reaching the preset condition is cleaning mode B.

In this embodiment, the oral cleaning equipment, under the condition that the operating state meets the preset condition, no longer responds to the selection operation applied to the mode control 110. That is, it maintains the selected target cleaning mode prior to the operating state reaching the preset condition. During this period, even if misoperation occurs, the oral cleaning equipment will not respond to the misoperation. This can reduce the probability of the oral cleaning equipment responding to false triggering operation, and improve the use effect of the oral cleaning equipment.

Optionally, the oral cleaning equipment can also include other components, such as the manipulation control (e.g., control 140 in FIG. 1). The manipulation control is at least configured to activate or deactivate the oral cleaning equipment. For another example, a power supply component is included to provide electrical energy to the oral cleaning equipment. The embodiment does not list the specific structures of the oral cleaning equipment.

The control method of the oral cleaning equipment will be described in detail below. The following embodiment illustrates the implementation of various control methods applied to the oral cleaning equipment shown in FIG. 1 as an example. In other implementations, the method can also be applied to other electronic devices that communicate with the oral cleaning equipment. These other electronic devices include, but are not limited to, mobile phones, wearable devices, computers, and/or tablets. The embodiment does not impose limitations on the types of other electronic devices.

FIG. 3 shows a flowchart of a control method for oral cleaning equipment according to an embodiment of the present disclosure. As shown in FIG. 3, the method includes at least the following steps.

Step 301: starting the oral cleaning equipment in response to a device startup command.

The methods by which the oral cleaning equipment obtains the device startup command include, but are not limited to, at least one of the following.

A first method: the oral cleaning equipment is provided with a manipulation control, and upon receiving a power-on operation applied to the manipulation control, the oral cleaning equipment is powered on through the power supply component and generates a device startup command to start the oral cleaning equipment.

Optionally, the probability of false triggering of the manipulation control is lower than the probability of false triggering of the mode control. In other words, the manipulation control is implemented as a component that is less prone to receiving false triggering operations. For example, the manipulation control can be a physical component (e.g., a physical button), or the manipulation control can be a component with fingerprint recognition functionality; and/or the manipulation control is arranged in a location less likely to receive false triggering operations, such as on the surface of the oral cleaning equipment, but in a position where it cannot be touched by the hand of the user during oral cleaning.

A second method: the oral cleaning equipment receives a device startup command sent by other electronic devices to start the equipment.

Illustratively, the oral cleaning equipment is arranged with a communication module and establishes a communication connection with other electronic devices based on the communication module. Correspondingly, when the other electronic device receives a power-on operation for starting the oral cleaning equipment, it generates a device startup command and transmits the device startup command to the oral cleaning equipment. Upon receiving the device startup command, the oral cleaning equipment communicates with the power supply component to start the device.

Herein, the communication connection between the oral cleaning equipment and other electronic devices includes, but is not limited to, Bluetooth connection or WiFi connection. The embodiment does not limit the method of establishing the communication connection.

Step 302: obtaining a selection operation applied to the mode control.

Step 303: controlling, once an operating state of the oral cleaning equipment meeting a preset condition, the oral cleaning equipment to maintain a target cleaning mode selected before the operating state meets the preset condition, wherein the selection operation is used to indicate a change in the target cleaning mode.

The target cleaning mode is one of at least two cleaning modes provided by the oral cleaning equipment. In one example, when the oral cleaning equipment obtains the selection operation, it determines whether the current operating state meets the preset condition. If the condition is met, it controls the oral cleaning equipment to maintain the target cleaning mode selected before the operating state reaches the preset condition.

In another example, the oral cleaning equipment periodically determines whether the current operating state meets the preset condition. If it determines that the preset condition is met, it controls the oral cleaning equipment to maintain the target cleaning mode selected before the operating state reaches the preset condition. At this point, step 303 can be executed before step 302, or it can also be executed after step 302, or it can be executed synchronously with step 302. The present disclosure does not limit the execution order between step 302 and step 303.

In another example, when the operating state of the oral cleaning equipment meets the preset condition, the mode control is disabled to control the oral cleaning equipment to maintain the target cleaning mode selected before the operating state reaches the preset condition upon obtaining the selection operation. In other words, when the mode control is disabled, the oral cleaning equipment no longer responds to the selection operation. At this point, step 303 can be executed before step 302, or it can also be executed after step 302, or it can be executed synchronously with step 302. The present disclosure does not limit the execution order between step 302 and step 303.

In the example, the mode control is disabled to block the selection operation, allowing the oral cleaning equipment to avoid repeatedly comparing the operating state with the preset condition, thereby conserving equipment resources.

Optionally, the method of disabling the mode control includes but is not limited to one of the following methods.

For the first method, a state marker of the mode control is set as a first marker. When the mode control is not disabled, the state marker of the mode control is a second marker.

For the second method, the mode control is implemented via a touch display screen. After obtaining the device startup command, the touch display screen is controlled to light up, and a communication connection is established with the touch display screen (e.g., a communication connection between the touch display screen and control module 120) to respond to the touch operation applied on the touch display screen. Accordingly, the step of disabling the mode control includes: disconnecting the communication connection to stop responding to the touch operation applied on the touch display screen. The touch operation includes the selection operation.

In the second implementation method, after the mode control is disabled, the control module no longer needs to communicate with the touch display screen, thereby conserving the communication resources of the oral cleaning equipment.

Optionally, the operating states of the oral cleaning equipment include at least one of the following:
1. a standby state, referring to a state in which the oral cleaning equipment is started and does not operate according to any cleaning mode; and
2. a working state, referring to a state where the oral cleaning equipment operates according to the target cleaning mode.

In other embodiments, the operating states can be further divided into other states, such as fault state or low-power state (essentially a standby state), etc. The present disclosure does not limit the division method of operating states.

Each operating state corresponds to a target cleaning mode that has been selected. The description of the target cleaning mode selected before the operating state reaches the preset condition is detailed in the embodiment shown in FIG. 1. The present embodiment does not elaborate further.

In one example, the method of selecting the target cleaning mode in the standby state includes but is not limited to the following: the oral cleaning equipment defaults to a specific cleaning mode; or the oral cleaning equipment uses the cleaning mode operated during the previous working state, or the cleaning mode selected by the mode control, during the current standby state and before the operating state reaches the preset condition. The present disclosure does not limit the method of selecting the target cleaning mode in the standby state.

In one example, the method of selecting the target cleaning mode in the working state includes but is not limited to the following: the target cleaning mode selected in the standby state; or the cleaning mode selected by the mode control, during the current working state and before the operating state reaches the preset condition. The present disclosure does not limit the method of selecting the target cleaning mode in the working state.

Optionally, the preset condition is determined based on the operating state of the oral cleaning equipment in scenarios prone to accidental touches; and/or, the preset condition is determined based on the operating state of the oral cleaning equipment when the user selects a cleaning mode.

For example, when the oral cleaning equipment is in the working state and starts operating in the target cleaning mode for a period of time, the probability of accidentally touching the mode control due to the water splashes is relatively low because there are not many water splashes around the oral cleaning equipment. However, once the period of time is exceeded, the water volume around the oral cleaning equipment increases significantly, and the probability of accidentally touching the mode control due to the water splashes becomes higher. At the same time, after starting the target cleaning mode of the oral cleaning equipment, users may find the mode unsuitable and often switch cleaning modes within a duration after startup. Therefore, the probability of the received selection operations being accidental touches during this duration is relatively low. However, once this duration is exceeded, users generally start using the oral cleaning equipment for oral cleaning, and the probability of the received selection operations being misoperations is higher.

Based on the above scenario, the preset condition can include the following: the oral cleaning equipment operates according to the target cleaning mode and the continuous working duration of the target cleaning mode is greater than a first duration threshold.

Optionally, the first duration threshold is greater than 0 and less than the preset working duration corresponding to the target cleaning mode. For example, the first duration threshold can be a value selected from the range [1, 10] seconds, such as 3s. The present disclosure does not limit the value of the first duration threshold.

Optionally, the first duration threshold corresponding to different cleaning modes can be the same or different. The first duration threshold can be a fixed value built into the oral cleaning equipment, a value set by the user, or a value sent by other electronic devices. The present disclosure does not limit the method of setting the first duration threshold.

Correspondingly, step 303 includes: controlling, in response to a working command for starting the target cleaning mode, the oral cleaning equipment to operate according to the target cleaning mode; and controlling the oral cleaning equipment to continue operating according to the target cleaning mode, under a condition that a continuous working duration of the target cleaning mode is greater than a first duration threshold.

Optionally, the step of obtaining the working command to start the target cleaning mode includes: generating the working command to start the target cleaning mode when receiving a mode start operation applied to the manipulation control.

Herein, the manipulation control that receives the mode start operation and the manipulation control that receives the power-on operation can be the same manipulation control or different manipulation controls. The present disclosure does not limit the number or usage of manipulation controls.

In other embodiments, the working command can also be sent by other electronic devices. The present disclosure does not limit the method of obtaining the working command.

For example, when the oral cleaning equipment is in the standby state, the probability of the user selecting the target cleaning mode is relatively high within a duration after entering the standby state. Once this duration is exceeded, the probability of selection operations received by the oral cleaning equipment being misoperations increases.

Based on the above scenario, the preset condition can include the continuous standby duration of the oral cleaning equipment in the standby state exceeding a second duration threshold.

Optionally, the second duration threshold can be the same as or different from the first duration threshold. Optionally, the second duration threshold is greater than 0. For example, the second duration threshold can be a value selected from the range [1, 10] seconds, such as 5s. The present disclosure does not limit the value of the second duration threshold.

Correspondingly, step 303 includes: controlling the oral cleaning equipment to maintain the cleaning mode selected before a standby duration reaches a second duration threshold, under a condition that a continuous standby duration of the oral cleaning equipment in a standby state is greater than the second duration threshold.

In the present disclosure, the scenarios where the oral cleaning equipment is in the standby state include, but are not limited to, at least one of the following:
scenario 1: the oral cleaning equipment enters the standby state after being powered on; and
scenario 2: the oral cleaning equipment enters the standby state after receiving a stop working command while in the working state.

The method of obtaining the stop working command includes, but is not limited to, at least one of the following.

First method: generating the stop working command upon receiving a mode pause operation applied to the manipulation control.

For example, the mode pause operation and the mode start operation are the same operations performed under different operational states. For instance, both the mode pause operation and the mode start operation can be operations of short pressing to the manipulation control. If the oral cleaning equipment is in the standby state and a short press operation applied to the manipulation control is received, the operation is a mode start operation. If the oral cleaning equipment is in the working state and a short press operation applied to the manipulation control is received, the operation is a mode pause operation.

In other embodiments, the mode pause operation and the mode start operation can also be different operations. For example, the mode start operation can be a single short press operation, and the mode pause operation can be multiple short press operations. The present disclosure does not limit the implementation of the mode pause operation and the mode start operation.

In the present disclosure, the term “short press” refers to pressing the manipulation control for a duration less than the first press threshold, where the first press threshold can be Is or 0.5s. The present disclosure does not limit the value of the first press threshold.

Second method: generating the stop working command when the working duration of the target cleaning mode selected in the current working state reaches the preset working duration corresponding to the target cleaning mode.

Optionally, the preset working duration corresponding to different target cleaning modes can be the same or different.

The working duration of the target cleaning mode refers to the total time the oral cleaning equipment continuously works according to the same target cleaning mode during the current power-on process.

For example, after powering on the oral cleaning equipment, it responds to the working command of cleaning mode A and works according to cleaning mode A. After working for a duration of “a”, if a mode pause operation applied to the manipulation control is obtained, the oral cleaning equipment enters the standby state. Then, if the mode start operation applied to the manipulation control is obtained again, the oral cleaning equipment resumes working according to cleaning mode A. After working for a duration of “b”, the total working duration of cleaning mode A is “a+b”, and when the value of “a+b” equals the preset working duration “c” corresponding to cleaning mode A, it indicates that the oral cleaning equipment has completed the cleaning task of cleaning mode A, and the stop working command is generated.

In the above process, if the oral cleaning equipment changes the cleaning mode after working in cleaning mode A for the duration “a”, the working duration of cleaning mode A is updated to 0.

In other embodiments, the oral cleaning equipment can also trigger the generation of the stop working command in other ways, such as generating the stop working command when the remaining power of the oral cleaning equipment falls below a threshold for lighting on, etc. The present disclosure does not limit the method of generating the stop working command.

Optionally, the oral cleaning equipment is controlled to change the target cleaning mode to the cleaning mode indicated by the selection operation, under a condition that the operating state of the oral cleaning equipment does not meet the preset condition.

In summary, the embodiment provides a control method for oral cleaning equipment, where the oral cleaning equipment is started by responding to the device startup command, and the selection operation applied to the mode control is obtained. Under the condition that the operating state of the oral cleaning equipment meets a preset condition, the oral cleaning equipment is controlled to maintain the target cleaning mode selected before the operating state reaches the preset condition, enabling that the oral cleaning equipment, under the condition that the operating state meets the preset condition, no longer responds to the selection operation applied to the mode control. During this period, even if misoperation occurs, the oral cleaning equipment will not respond to the misoperation. This can solve the problem of the high probability of oral cleaning equipment responding to misoperations, and improve the use effect of the oral cleaning equipment.

Moreover, by setting the preset conditions, where the oral cleaning equipment operates according to the target cleaning mode and the continuous working duration of the target cleaning mode is greater than a first duration threshold, and/or, the continuous standby duration of the oral cleaning equipment in the standby state is greater than a second duration threshold, the oral cleaning equipment can activate the anti-misoperation mechanism when in a misoperation-prone scenario, and not activate the anti-misoperation mechanism when not in the misoperation-prone scenario, thereby improving the accuracy of the timing for activating the anti-misoperation mechanism.

Optionally, in the above embodiment, after the step of disabling the mode control, the method further includes: obtaining a disable-release command to control the oral cleaning equipment to change the current operating state to the cleaning mode indicated by the selection operation, in the case of obtaining the selection operation.

At this time, after the mode control is disabled, the disablement can be released by obtaining a disable-release command, so that the user can select the cleaning mode normally. Optionally, in order to avoid that the disable-release command is generated based on a false triggering operation, the disable-release command is not generated by triggering the mode control; or the disable-release command is triggered differently than the selection operation.

Optionally, the method of generating the disable-release command includes but is not limited to one of the following methods.

A first method: providing the oral cleaning equipment a manipulation control independent of the mode control. Correspondingly, the disable-release command is generated, in a case of receiving a first preset operation applied to the manipulation control.

Illustratively, the first preset operation includes but is not limited to: a single short press of the manipulation control, multiple short presses of the manipulation control, or a long press of the manipulation control, etc. The present disclosure does not limit the operation method of the first preset operation. The term “long press” refers to pressing the manipulation control for a duration greater than a second press threshold, and the second press threshold is greater than or equal to the first press threshold. The present disclosure does not limit the value of the second press threshold.

Optionally, if the oral cleaning equipment operates in a working state according to the target cleaning mode, then upon receiving the first preset operation, based on the first preset operation, the oral cleaning equipment is controlled to stop working according to the target cleaning mode. In other words, the mode pause operation in the above embodiment includes the first preset operation.

When the user needs to pause the oral cleaning, they often trigger the oral cleaning equipment to pause the working state, and at this time the probability of misoperation is relatively low. Therefore, the disabling of the mode control can be released, so as to restore the selection function of the cleaning mode. Based on this, by implementing the touch mode pause operation and the first preset operation as the same operation, the operation types that the control module needs to respond to can be simplified, thus saving the instruction resources of the control module.

In other embodiments, the first preset operation can also be different from the mode pause operation, for example, the first preset operation is a single short press of the manipulation control, and the mode pause operation is multiple short presses of the manipulation control. The present disclosure does not limit the relationship between the first preset operation and the mode pause operation.

A second method: the oral cleaning equipment receives disable-release commands sent by other electronic devices.

In the embodiment, the step of obtaining a disable-release command to control the oral cleaning equipment to change the current operating state to the operating state indicated by the selection operation, in the case of obtaining the selection operation includes:
changing the state marker of the mode control to a second marker in response to the disable-release command, wherein at this time, when the mode control is disabled, the state marker is the first marker;
or,
establishing a communication connection between the control module and the mode control in response to the disable-release command, wherein at this time, when the mode control is disabled, the communication connection between the control module and the mode control is disconnected.

In the embodiment, by receiving the disable-release command after disabling the manipulation control, the disabling of the manipulation control can be released, which allows the user to normally select the cleaning mode after releasing the manipulation control. This reduces the probability of misoperation while improving the flexibility of using the oral cleaning equipment.

Optionally, in the above embodiment, the manipulation control can be a control configured to control the power on and off of the oral cleaning equipment. Correspondingly, in the step 301, starting the oral cleaning equipment in response to a device startup command includes: generating the device startup command to start the oral cleaning equipment, in a case where the oral cleaning equipment is shut down, when the second preset operation applied to the manipulation control is received.

In other words, the power-on operation in the above embodiment includes: a second preset operation applied to the manipulation control.

After the step 301, the oral cleaning equipment is controlled to shut down, in a case where the oral cleaning equipment is started, when a second preset operation applied to the manipulation control is received.

In the embodiment, the power-on operation and the power-off operation have the same operation method, both being the second preset operation applied to the mode control. If the oral cleaning equipment is powered on, the received second preset operation is used to control the device to power off; if the oral cleaning equipment is powered off, the received second preset operation is used to control the device to power on.

In other embodiments, the operation methods of the power-on operation and the power-off operation can also be different, and the embodiment does not limit the operation methods of the power-on and power-off operations.

Herein, the second preset operation is different from the first preset operation, for example, the first preset operation is a short press of the manipulation control, and the second preset operation is a long press of the manipulation control.

In this embodiment, by implementing the control for controlling the power on and off of the oral cleaning equipment and the control for triggering the disable-release command as the same control, the number of controls in the oral cleaning equipment can be simplified, thereby simplifying the structure of the oral cleaning equipment.

In other embodiments, the control for controlling the power on and off of the oral cleaning equipment is not the same control as the control for triggering the disable-release command, that is, the two can be implemented by different controls; or the manipulation control corresponding to the power-on operation and the manipulation control corresponding to the power-off operation are implemented as different controls. The embodiment does not limit the implementation method of the power-on and power-off controls.

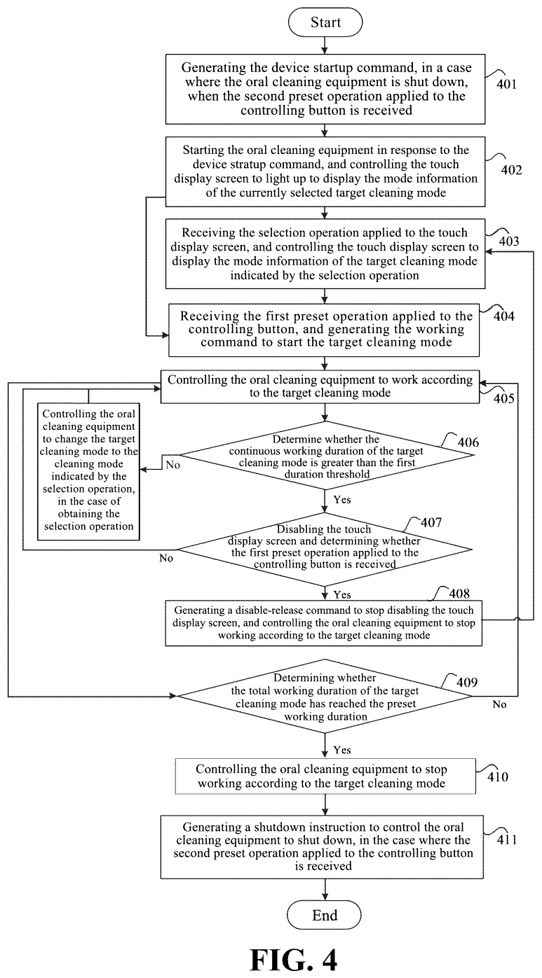

In order to more clearly understand the control method for oral cleaning equipment provided in the present disclosure, the above control method is illustrated below with examples. The preset condition in the embodiment includes the following. The oral cleaning equipment operates according to the target cleaning mode and the continuous working duration of the target cleaning mode is greater than a first duration threshold. The oral cleaning equipment includes a manipulation control and a mode control, and the mode control is implemented by a touch display screen as an example for explanation. Referring to FIG. 4, the method includes the following steps.

Step 401: generating the device startup command, in a case where the oral cleaning equipment is shut down, when the second preset operation applied to the manipulation control is received.

Herein, for the related description of the second preset operation, the above embodiment is referred to, which will not be repeated here in the embodiment.

Step 402: starting the oral cleaning equipment in response to the device startup command, and controlling the touch display screen to light up to display the mode information of the currently selected target cleaning mode; and executing step 403 or step 404.

Optionally, the touch display screen can display the mode information of at least two cleaning modes, with the mode information of the target cleaning mode displayed in a first display mode, and the mode information of other cleaning modes displayed in a second display mode, where the first display mode and the second display mode are different.

For example, the mode information of at least two cleaning modes is displayed in the form of a window scroll, where the mode information of the target cleaning mode is displayed in the center and enlarged, and the mode information of other cleaning modes is arranged on both sides of the mode information of the target cleaning mode and displayed in a reduced size.

For another example, the mode information of at least two cleaning modes is displayed at preset positions, where the mode information of the target cleaning mode is displayed in bold.

Alternatively, the touch display screen only displays the mode information of the target cleaning mode.

In this embodiment, the touch display screen always displays the mode information of the currently selected target cleaning mode. When the target cleaning mode changes, the mode information displayed on the touch display screen also changes accordingly. When the target cleaning mode remains unchanged, the mode information displayed on the touch display screen also remains unchanged. This will not be repeated below.

Optionally, after the oral cleaning equipment starts, it initializes the last used cleaning mode as the target cleaning mode; or it initializes the preset default cleaning mode as the target cleaning mode. The embodiment does not limit the method for initializing and determining the selected target cleaning mode.

In step 402, the oral cleaning equipment has not yet worked according to the target cleaning mode, i.e., the oral cleaning equipment is in the standby state.

Step 403: receiving the selection operation applied to the touch display screen, and controlling the touch display screen to display the mode information of the target cleaning mode indicated by the selection operation.

Optionally, the selection operation includes but is not limited to one of the following methods.

1. Sliding operation. The control module determines the currently selected target cleaning mode based on the direction and distance of the sliding operation, and displays the mode information of the target cleaning mode in the first display mode.

2. Clicking operation. The control module determines the currently selected target cleaning mode based on the location of the clicking operation, and displays the mode information of the target cleaning mode in the first display mode.

In other embodiments, the selection operation can also be other types of operations. The embodiment does not list them all.

Optionally, during the execution of step 403, the user can perform the selection operation multiple times on the touch display screen. Each time a selection operation is performed, the selected target cleaning mode replaces the target cleaning mode selected in the previous selection operation. That is, during the execution of subsequent step 404, the target cleaning mode started is the one selected by the most recent selection operation.

Step 404: receiving the first preset operation applied to the manipulation control, and generating the working command to start the target cleaning mode.

Since the manipulation control is a control that is not easily triggered by mistake, in the embodiment, the first preset operation applied to the manipulation control is used to start the target cleaning mode, which reduces the probability of the target cleaning mode being mis-started. For the related description of the first preset operation, the above embodiment is referred to, which will not be repeated here in the embodiment.

In other embodiments, the triggering operation to start the target cleaning mode can also not be the first preset operation, but another triggering operation different from both the first preset operation and second preset operation. The embodiment does not limit the type of triggering operation to start the target cleaning mode.

Furthermore, in other embodiments, the working command can also be sent by other electronic devices. The present disclosure does not limit the method of obtaining the working command.

Step 405: controlling the oral cleaning equipment to work according to the target cleaning mode, and executing steps 406 and 409.

Step 406: determine whether the continuous working duration of the target cleaning mode is greater than the first duration threshold; if yes, executing step 407; and if not, upon receiving a selection operation, changing the target cleaning mode to the cleaning mode indicated by the selection operation, and executing step 405; and when no selection operation is received, executing step 405 (not shown in FIG. 4).

The continuous working duration refers to the duration of time that the target cleaning mode is currently in the activated state. When stopping work according to the target cleaning mode, the continuous working duration is updated to 0.

The details of the first duration threshold are described in the above embodiment, which will not be repeated in the present embodiment.

Step 407: disabling the touch display screen, and determining whether the first preset operation applied to the manipulation control has been received; if the first preset operation is received, executing step 408; if the first preset operation is not received, executing step 405.

In the case of disabling the touch display screen, the touch display screen remains lit to display the mode information of the current target cleaning mode. The details of this step are described in the above embodiment, which will not be repeated in the present embodiment.

In step 407, if a selection operation applied to the touch display screen is received, since the touch display screen is disabled, the selection operation will not be responded to, i.e., the oral cleaning equipment will continue to work according to the target cleaning mode.

Step 408: generating a disable-release command to stop disabling the touch display screen, controlling the oral cleaning equipment to stop working according to the target cleaning mode, and executing steps 403 or 404.

At this point, the oral cleaning equipment enters the standby state.

In the embodiment, the execution of step 403 after step 408 is taken as an example for explanation. In actual implementation, if the oral cleaning equipment receives a selection operation after stopping operation, step 403 is executed. If no selection operation is received, but the first preset operation applied to the manipulation control is directly received, step 404 is executed.

Step 409: determining whether the working duration of the target cleaning mode has reached the preset working duration; executing step 410 when the working duration has reached the preset working duration; and execute step 405 when the working duration has not reached the preset working duration.

Step 410: controlling the oral cleaning equipment to stop working according to the target cleaning mode, and executing steps 403, 404, or 411.

In the case where the working duration of the same target cleaning mode reaches the preset working duration, the oral cleaning equipment stops working according to the target cleaning mode and updates the working duration of the target cleaning mode to 0.

In this embodiment, step 411 is explained after step 410 as an example. In actual implementation, if a selection operation is received after step 410, step 403 is executed. If no selection operation is received, but the first preset operation applied to the manipulation control is directly received, step 404 is executed. At this point, in response to the working command of the target cleaning mode, the working duration and continuous working duration of the target cleaning mode both start counting from 0.

Step 411: generating a shutdown command to control the oral cleaning equipment to shut down, in the case where the second preset operation applied to the manipulation control is received.

After the oral cleaning equipment is shut down, the power supply component no longer provides power to the oral cleaning equipment, and the touch display screen goes dark.

Additionally, step 411 can be executed at any time after step 402, that is, step 411 does not necessarily need to be executed after step 410. The specific execution timing is determined by whether the second preset operation applied to the manipulation control is received.

Furthermore, after executing step 410, the oral cleaning equipment can also automatically shut down directly, without executing step 411.

In summary, in the embodiment, by disabling the touch display screen when the continuous working duration of the target cleaning mode is greater than the first duration threshold during the working state, it ensures that the oral cleaning equipment will not respond to selection operations applied to the touch display screen in an easily mis-triggered working state, thus avoiding the problem of the oral cleaning equipment working in a user-undesired cleaning mode and improving the effectiveness of the oral cleaning equipment.

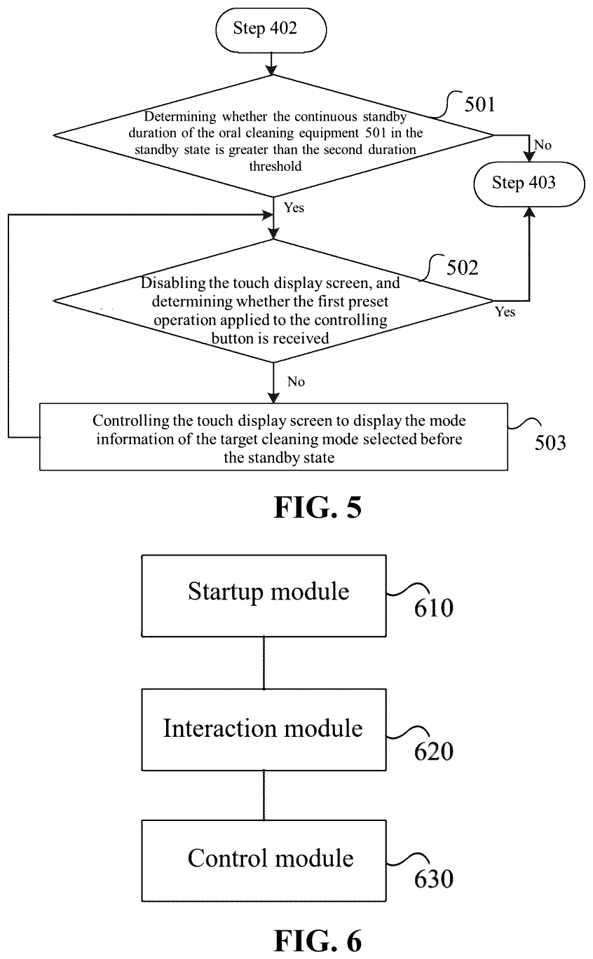

Optionally, based on the embodiment shown in FIG. 4, the preset condition can further include the continuous standby duration of the oral cleaning equipment in the standby state exceeding a second duration threshold. At this point, referring to FIG. 5, at least the following steps are included after step 402 and before step 403.

Step 501: determining whether the continuous standby duration of the oral cleaning equipment in the standby state is greater than the second duration threshold; if no, executing step 403; and if yes, executing step 502.

Step 502: disabling the touch display screen, and determining whether the first preset operation applied to the manipulation control is received; if yes, executing step 403; and if no, executing step 503.

In this embodiment, if the oral cleaning equipment is in the standby state and the touch display screen is currently disabled, the received first preset operation is used to generate the disable-release command. At this point, the oral cleaning equipment can control the touch display screen to display the mode information of the target cleaning mode indicated by the selection operation based on the selection operation, i.e., executing step 403.

If the oral cleaning equipment is in the standby state and the touch display screen is not currently disabled, the received first preset operation is used to start the target cleaning mode, i.e., executing step 404.

For example, supposing the first preset operation is a short press of the manipulation control, if the oral cleaning equipment is in the standby state and the touch display screen is currently disabled, then the user short presses the manipulation control for the first time and the disabling of the touch display screen is released, but the oral cleaning equipment has not yet started working according to the target cleaning mode. The second short press of the manipulation control triggers the oral cleaning equipment to start working according to the target cleaning mode.

Step 503: controlling the touch display screen to display the mode information of the target cleaning mode selected before the standby state, and executing step 502.

In step 503, regardless of whether a selection operation applied to the touch display screen is received, the mode information displayed on the touch display screen does not change, i.e., the mode information of the target cleaning mode selected before the standby state.

In the embodiment of FIG. 4, each step can jump to step 501 after switching to the standby state. For example, after step 408, step 501 is executed; after step 410, step 501 is executed.

In summary, in this embodiment, by disabling the touch display screen when the continuous standby duration in the standby state is greater than the second duration threshold, it ensures that the oral cleaning equipment will not respond to selection operations applied to the touch display screen in an easily mis-triggered standby state, thus avoiding the problem of the oral cleaning equipment being started in a user-undesired cleaning mode and improving the effectiveness of the oral cleaning equipment.

In other embodiments, the preset condition can only include the continuous standby duration of the oral cleaning equipment in the standby state exceeding a second duration threshold. At this time, there is no need to execute steps 406 to 408, and the present disclosure does not limit the specific implementation method of the preset conditions.

FIG. 6 is a block diagram of a control device for oral cleaning equipment provided in an embodiment of the present disclosure. The embodiment is described by taking the device applied to the oral cleaning equipment shown in FIG. 1 as an example. The device at least includes the following modules: a startup module 610, an interaction module 620, and a control module 630.

The startup module 610 is configured for responding to a device startup command to start the oral cleaning equipment.

The interaction module 620 is configured for obtaining a selection operation applied to the mode control.

The control module 630 is configured for controlling, under a condition that an operating state of the oral cleaning equipment meets a preset condition, the oral cleaning equipment to maintain a target cleaning mode selected before the operating state reaches the preset condition,
wherein the selection operation is used to indicate changing the target cleaning mode, and the target cleaning mode is one of the at least two cleaning modes.

Optionally, the device can be arranged in the control module 120.

The related description can be found in the above method embodiment.

In some embodiments, the functions provided by the device of the present disclosure or the modules included can be used to execute the methods described in the above method embodiment, and the specific implementation can refer to the description in the above method embodiment. For brevity, the details are not repeated herein.

The embodiment of the present disclosure further provides a computer-readable storage medium, on which computer program instructions are stored, wherein the computer program instructions, when executed by a processor, implement the above method. The computer-readable storage medium can be a volatile or non-volatile computer-readable storage medium.

The embodiment of the present disclosure further provides an electronic device, including: a processor; and a memory configured for storing processor-executable instructions, wherein the processor is configured to implement the above method when executing the instructions stored in the memory.

The embodiment of the present disclosure further provides a computer program product, including computer-readable code, or a non-volatile computer-readable storage medium carrying computer-readable code, wherein when the computer-readable code is run in the processor of an electronic device, the processor of the electronic device performs the above method.

The above has described various embodiments of the present disclosure. The above description is illustrative and not exhaustive, and is not limited to the disclosed embodiments. Many modifications and changes will be apparent to those skilled in the art without departing from the scope and spirit of the described embodiments. The selection of terms used herein is intended to best explain the principles of the various embodiments, the practical applications, or the technical improvements in the market, or to enable those skilled in the art to understand the embodiments disclosed herein.

What is claimed is:

1. A control method for oral cleaning equipment, having at least two cleaning modes, and provided with a mode control configured for selecting the cleaning mode, wherein the method comprises steps of:
starting the oral cleaning equipment in response to a device startup command;
obtaining a selection operation applied to the mode control; and
controlling, once an operating state of the oral cleaning equipment meeting a preset condition, the oral cleaning equipment to maintain a target cleaning mode selected before the operating state meets the preset condition,
wherein the selection operation is used to indicate change of the target cleaning mode, and the target cleaning mode is one of the at least two cleaning modes.

2. The method according to claim 1, wherein the step of controlling, once an operating state of the oral cleaning equipment meeting a preset condition, the oral cleaning equipment to maintain a target cleaning mode selected before the operating state meets the preset condition, comprises:
disabling the mode control once the operating state meeting the preset conditions, so as to control, upon obtaining the selection operation, the oral cleaning equipment to maintain the target cleaning mode selected before the operating state meets the preset condition.

3. The method according to claim 2, wherein the mode control is implemented through a touch display screen; and correspondingly,
the method further comprises:
controlling, after obtaining the device startup command, the touch display screen to light up, and establishing a communication connection with the touch display screen to respond to a touch operation applied to the touch display screen;
and correspondingly,
the step of disabling the mode control comprises:
disconnecting the communication connection to stop responding to the touch operation applied to the touch display screen,
wherein the touch operation comprises the selection operation.

4. The method according to claim 2, after the step of disabling the mode control, further comprising:
obtaining a disable-release command, to control, upon obtaining the selection operation, the oral cleaning equipment to change the target cleaning mode to the cleaning mode indicated by the selection operation.

5. The method according to claim 4, wherein the oral cleaning equipment is further provided with a manipulation control independent of the mode control; and correspondingly, the method further comprises:
generating the disable-release command, upon receiving a first preset operation applied to the manipulation control.

6. The method according to claim 5, wherein the operating state comprises: a working state according to the target cleaning mode; and correspondingly, the method further comprises:
controlling, based on the first preset operation, the oral cleaning equipment to stop operating according to the target cleaning mode.

7. The method according to claim 5, further comprising:
controlling, in a case where the oral cleaning equipment is started, the oral cleaning equipment to shut down when a second preset operation applied to the manipulation control is received.

8. The method according to claim 7, wherein the step of starting the oral cleaning equipment in response to a device startup command comprises:
generating, in a case where the oral cleaning equipment is shut down, the device startup command to start the oral cleaning equipment when the second preset operation applied to the manipulation control is received.

9. The method according to claim 1, wherein the step of controlling, once an operating state of the oral cleaning equipment meeting a preset condition, the oral cleaning equipment to maintain a target cleaning mode selected before the operating state meets the preset condition, comprises:
controlling, in response to a working command for starting the target cleaning mode, the oral cleaning equipment to operate according to the target cleaning mode; and
controlling, in a case where a working duration of the target cleaning mode is greater than a first duration threshold, the oral cleaning equipment to continue operating according to the target cleaning mode.

10. The method according to claim 1, wherein the step of controlling, once an operating state of the oral cleaning equipment meeting a preset condition, the oral cleaning equipment to maintain a target cleaning mode selected before the operating state meets the preset condition, comprises:
controlling, in a case where a continuous standby duration of the oral cleaning equipment in a standby state is greater than a second duration threshold, the oral cleaning equipment to maintain the cleaning mode selected before the continuous standby duration meets the second duration threshold,
wherein the standby state refers to a state in which the oral cleaning equipment is started and does not operate according to any cleaning mode, and the continuous standby duration refers to a duration during which the oral cleaning equipment continuously remains in the standby state.

11. The method according to claim 1, further comprising:
controlling, in a case where the operating state of the oral cleaning equipment does not meet the preset condition, the oral cleaning equipment to change the target cleaning mode to the cleaning mode indicated by the selection operation.

12. A control device for oral cleaning equipment, comprising
a processor; and
a memory configured for storing processor-executable instructions,
wherein the processor is configured to implement the method according to claim 1 when executing the instructions stored in the memory.

13. A non-volatile computer-readable storage medium, storing computer program instructions thereon, wherein the computer program instructions, when executed by a processor, implement the method according to claim 1.

14. The method according to claim 2, wherein the step of controlling, once an operating state of the oral cleaning equipment meeting a preset condition, the oral cleaning equipment to maintain a target cleaning mode selected before the operating state meets the preset condition, comprises:
controlling, in response to a working command for starting the target cleaning mode, the oral cleaning equipment to operate according to the target cleaning mode; and
controlling, in a case where a working duration of the target cleaning mode is greater than a first duration threshold, the oral cleaning equipment to continue operating according to the target cleaning mode.

15. The method according to claim 3, wherein the step of controlling, once an operating state of the oral cleaning equipment meeting a preset condition, the oral cleaning equipment to maintain a target cleaning mode selected before the operating state meets the preset condition, comprises:
controlling, in response to a working command for starting the target cleaning mode, the oral cleaning equipment to operate according to the target cleaning mode; and
controlling, in a case where a working duration of the target cleaning mode is greater than a first duration threshold, the oral cleaning equipment to continue operating according to the target cleaning mode.

16. The method according to claim 4, wherein the step of controlling, once an operating state of the oral cleaning equipment meeting a preset condition, the oral cleaning equipment to maintain a target cleaning mode selected before the operating state meets the preset condition, comprises:
controlling, in response to a working command for starting the target cleaning mode, the oral cleaning equipment to operate according to the target cleaning mode; and
controlling, in a case where a working duration of the target cleaning mode is greater than a first duration threshold, the oral cleaning equipment to continue operating according to the target cleaning mode.

17. The method according to claim 5, wherein the step of controlling, once an operating state of the oral cleaning equipment meeting a preset condition, the oral cleaning equipment to maintain a target cleaning mode selected before the operating state meets the preset condition, comprises:
controlling, in response to a working command for starting the target cleaning mode, the oral cleaning equipment to operate according to the target cleaning mode; and
controlling, in a case where a working duration of the target cleaning mode is greater than a first duration threshold, the oral cleaning equipment to continue operating according to the target cleaning mode.

18. The method according to claim 6, wherein the step of controlling, once an operating state of the oral cleaning equipment meeting a preset condition, the oral cleaning equipment to maintain a target cleaning mode selected before the operating state meets the preset condition, comprises:
controlling, in response to a working command for starting the target cleaning mode, the oral cleaning equipment to operate according to the target cleaning mode; and
controlling, in a case where a working duration of the target cleaning mode is greater than a first duration threshold, the oral cleaning equipment to continue operating according to the target cleaning mode.

19. The method according to claim 7, wherein the step of controlling, once an operating state of the oral cleaning equipment meeting a preset condition, the oral cleaning equipment to maintain a target cleaning mode selected before the operating state meets the preset condition, comprises:
controlling, in response to a working command for starting the target cleaning mode, the oral cleaning equipment to operate according to the target cleaning mode; and
controlling, in a case where a working duration of the target cleaning mode is greater than a first duration threshold, the oral cleaning equipment to continue operating according to the target cleaning mode.

20. The method according to claim 8, wherein the step of controlling, once an operating state of the oral cleaning equipment meeting a preset condition, the oral cleaning equipment to maintain a target cleaning mode selected before the operating state meets the preset condition, comprises:
controlling, in response to a working command for starting the target cleaning mode, the oral cleaning equipment to operate according to the target cleaning mode; and
controlling, in a case where a working duration of the target cleaning mode is greater than a first duration threshold, the oral cleaning equipment to continue operating according to the target cleaning mode.
